(19) United States
(12) Patent Application Publication
(10) Pub. No.: US 2021/0203200 A1
(43) Pub. Date: Jul. 1, 2021

(54) ROTOR FOR ELECTRIC MOTOR AND BRUSHLESS MOTOR

(71) Applicant: MITSUBA Corporation, Gunma (JP)

(72) Inventors: Yuichi SHIONO, Gunma (JP); Masanori SATO, Gunma (JP); Hisashi ISHIDA, Gunma (JP); Tohru YUMOTO, Gunma (JP)

(73) Assignee: MITSUBA Corporation, Gunma (JP)

(21) Appl. No.: 16/081,419

(22) PCT Filed: Mar. 17, 2017
(86) PCT No.: PCT/JP2017/010942

§ 371 Date: Aug. 31, 2018

(30) Foreign Application Priority Data
Mar. 17, 2016 (JP) 2016-054120

(51) Int. Cl. H02K 1/30; H02K 1/27; H02K 21/14

(52) U.S. Cl. CPC H02K 1/30; H02K 21/14; H02K 1/276

(57) ABSTRACT

In the present invention a rotor core is formed by multiple divided cores that are separated from one another, and side core plates that link the outer circumferential ends of the divided cores in the circumferential direction. Slits into which magnets are inserted are maintained between the divided cores. The rotor core and a rotary shaft are coupled to one another by a molded resin, and the molded resin covers protrusions which are on both sides in the circumferential direction at the inner circumferential end of each divided core.

### BACKGROUND OF THE INVENTION

### Technical Field

The present invention relates to a rotor for electric motor, and a brushless motor that includes the rotor for electric motor.

The present application claims the priority to Japanese Patent Application No. 2016-054120 filed in Japan on Mar. 17, 2016, and the content thereof is incorporated herein.

### Related Art

Conventionally, as an electric motor, the following brushless motor is known which includes a stator that has teeth on which a winding wire is wound, and a rotor that is rotatably provided in a radial direction on the inside of the rotor, and drives the rotor to rotate by controlling an energization to the winding wire.

The rotor of such brushless motor has a rotary shaft, a rotor core of substantially cylindrical shape that is externally fixed on the rotary shaft, and magnets that are provided on the rotor core.

A method of for arranging the magnets on the rotor is known as a magnet embedding method (IPM: Interior Permanent Magnet), in which multiple slits are formed in the rotor core made of a magnetic body and the magnets are arranged inside the slits.

In addition, in recent years, among IPM motors, a PMR (Permanent Magnetic Reluctance) motor is known, in which a large reluctance torque is generated since the magnets are provided inside the rotor core along the radial direction and have a strong shape of magnetic anisotropy.

The PMR motor generates a magnetic flux in a circumferential direction of the magnets, and magnetizes the rotor core between the magnets. Therefore, a leakage of the magnetic flux of the magnets in the radial direction is required to be suppressed in order to magnetize the rotor core with a good magnetic efficiency.

Meanwhile, in general, pressing is used as a fixing method of the rotary shaft and the rotor core (for example, see patent literature 1).

### LITERATURE OF RELATED ART

### Patent Literature

Patent literature 1: Japanese Laid-open No. 2013-102597

### SUMMARY

### Problems to be Solved

However, although the rotor described above can maintain a high coupling strength when the rotary shaft and the rotor core are coupled by pressing the rotary shaft into a central hole of the rotor core, bulged portions that form multiple magnetic pole portions of the rotor core around the pressing hole are linked to one another in a circumferential direction. Therefore, there is a possibility that the leakage of the magnetic flux in an inner circumference of the rotor core may not be reduced.

The present invention provides a rotor for electric motor which can significantly reduce a leakage magnetic flux and tightly hold the rotor core on the rotary shaft, and a brushless motor that includes the rotor for electric motor.

### Means to Solve the Problems

According to a first aspect of the present invention, a rotor for electric motor includes a rotary shaft; a non-magnetic body, formed to cover an outer circumferential surface of the rotary shaft; a rotor core, linked to the outer circumference of the rotary shaft through the non-magnetic body, and a plurality of slits that extend in an axial direction and a radial direction of the rotary shaft being formed side by side along a circumferential direction of the rotary shaft; and a plurality of magnets, provided in the plurality of the slits. The rotor core is formed in a manner that there is a space between an inner circumferential surface side of the rotor core and the outer circumferential surface of the rotary shaft. Protrusions are provided on an inner circumferential side of the rotor core to suppress the rotor core from being separated from the non-magnetic body toward the outside of the radial direction, and grooves are provided on the non-magnetic body to receive the protrusions and engage with the protrusions.

As described above, the rotary shaft and the rotor core are linked through the non-magnetic body, and furthermore, there is a space between the outer circumferential surface of the rotary shaft and the inner circumference of the rotor core. In this manner, a leakage magnetic flux in an inner circumference portion of the rotor core can be significantly reduced.

In addition, the protrusions are provided on the rotor core to prevent a falling toward the outside of the radial direction, and on the other hand, the grooves engaged with the protrusions are provided on the non-magnetic body, by which the rotor core can be tightly held on the rotary shaft. Furthermore, the position of the magnets at the inner side end in the radial direction can be restricted by the non-magnetic body, so that an amount of the magnetic flux generated on the outer circumferential surface of the rotor core can be uniformed over the entire periphery of the rotor core.

In addition, the non-magnetic body is interposed between the rotary shaft and the rotor core, so that a diameter of the rotary shaft may be reduced. For example, even when a shaft diameter is small, the rotor core can be reliably held, and therefore, it is preferable for a case when the shaft diameter is small.

According to a second aspect of the present invention, in the rotor for electric motor of the first aspect of the present invention, the rotor core includes a plurality of divided cores, extending in the axial direction and the radial direction, and are arranged radially on the outer circumferential surface of the rotary shaft; and a side core plate, arranged on at least one end in the axial direction of the divided cores. The slits are formed between each divided core. The side core plate incudes a plurality of core piece bodies, having the same shape as the divided cores and being engaged with each divided core; and linking portions, respectively link outer circumference portions in the radial direction of the core piece bodies.

As described above, the rotor core is formed by the divided cores, so that the leakage magnetic flux in the inner circumference portion of the rotor core can be reduced more reliably. In addition, since each divided core is linked by the linking portions of the side core plates in the circumferential direction, an integral rotor core can be simply formed although the separated divided cores are used, and the magnets can be reliably held by each divided core.

According to a third aspect of the present invention, in the rotor for electric motor of the second aspect of the present invention, the rotor core is formed by laminating a plurality of steel sheet materials in the axial direction; and the side core plate is made of one piece or multiple pieces of the steel sheet materials that are arranged on end portions in the axial direction of the laminated steel sheet materials.

By the configuration configured as described above, except the side core plates that are positioned on end portions in the axial direction, there is no portion (linking portion) connecting the divided cores that are separated from one another in the circumferential direction, so that the leakage magnetic flux can be minimized.

According to a fourth aspect of the present invention, in the rotor for electric motor of the third aspect of the present invention, the steel sheet materials that are laminated are linked with one another by convex portions and concave portions capable of engaging with the convex portions, and the concave portions and the convex portions are formed on respective lamination surfaces.

By the configuration described above, so that the rotor core can be inexpensively made by laminating prescribed pieces of the steel sheet materials which are pressed into a prescribed shape. In addition, it is possible to adjust the lamination pieces of the steel sheet material to correspond the motor specifications.

According to a fifth aspect the present invention, in the rotor for electric motor of any one of the second to fourth aspects of the present invention, each divided core is provided with magnet guiding projections, and the magnet guiding projections are formed on at least one of two sides that face the divided cores adjacent in the circumferential direction and formed to protrude along the circumferential direction on an outer side end in the radial direction.

As described above, by forming the magnet guiding projections to protrude along the circumferential direction on the side surface of the divided cores and on the outer side end in the radial direction, the magnets can be inserted into each slit along the magnet guiding projections. That is, by using the magnet guiding projections, the magnets can be easily inserted into each slit, and an assembling property of the magnets can be improved.

In addition, since the magnet guiding projections protrude on the slit side, the magnets can be prevented from coming outward in the radial direction by the magnet guiding projections. Therefore, a holding force of the magnets by the divided cores can be further improved.

According to a sixth aspect of the present invention, in the rotor for electric motor of the fifth aspect of the present invention, the magnet guiding projections are provided within a projection surface of the linking portions when the rotor core is viewed from the axial direction.

By the configuration described above, when the magnets are inserted into each slit along the axial direction, the magnets can be inserted smoothly without being caught by the magnet guiding projections.

According to a seventh aspect of the present invention, in the rotor for electric motor of any one of the second to sixth aspects of the present invention, the non-magnetic body has protrusion out portions that protrude in the axial direction toward an outside of two end surfaces of the rotor core. Each protrusion portion has a pair of radial protrusion portions that protrude outward in the radial direction so as to cover a portion of the two end surfaces in the axial direction of the rotor core. On the end surfaces in the axial direction of the rotor core, at least one of the pair of the radial protrusion portions extends in the radial direction avoiding the slits.

By the configuration described above, even when radial protrusion portions are provided on the non-magnetic body, an insertion entrance of the magnets to each slit can be secured.

According to an eighth aspect of the present invention, in the rotor for electric motor of the seventh aspect of the present invention, on the end surfaces in the axial direction of the rotor core, the other one of the pair of radial protrusion portions extends in the radial direction to a position that covers a portion of the slits.

By the configuration described above, the positioning of the magnets in the axial direction can be simply performed by making the end portions of the magnets in the axial direction abut against the radial protrusion portions. In addition, since the radial protrusion portions also have a function of preventing the coming out of the magnets in the axial direction, the rotor for electric motor with high reliability can be provided.

According to a ninth aspect of the present invention, in the rotor for electric motor of the eighth aspect of the present invention, the other one of the radial protrusion portions has a plurality of positioning recesses that correspond to the slits and determine positions of end portions of the magnets in the axial direction protruding from an end portion in the axial direction of the rotor core.

By the configuration described above, the positioning of the magnets can be performed easily and more accurately.

According to a tenth aspect of the present invention, in the rotor for electric motor of any one of the seventh to ninth aspects of the present invention, the divided cores and the side core plates are linked with one another by engaging convexes that are formed on either of the divided cores and the side core plates, and engaging concaves that are formed on the other of the divided cores and the side core plates and are able to be engaged with the engaging convexes. The radial protrusion portions are formed to cover at least one portion of the engaging convexes and the engaging concaves.

By the configuration described above, the divided cores and the side core plates can be easily and reliably linked by the engaging convexes and the engaging concaves.

In addition, since the radial protrusion portions of the non-magnetic body are formed to cover at least one portion of the engaging convexes and the engaging concaves, a fixing force to the non-magnetic body and the rotor core can be improved.

According to an eleventh aspect of the present invention, in the rotor for electric motor of any one of the seventh to ninth aspects of the present invention, the divided cores and the side core plates are linked with one another by engaging convexes that are formed on the divided cores, and engaging holes that are formed on the side core plates and are able to be fitted to the engaging convexes. The radial protrusion portions are formed to cover at least a portion of the engaging convexes and the engaging holes.

By the configuration described above, the divided cores and the side core plates can be easily and reliably linked by the engaging projections and the engaging holes.

In addition, by the configuration of fitting the engaging convexes to the engaging holes of the side core plates, when linking the divided cores and the side core plates, a surface of the side core plate can be made flat without concave and convex formed on the surface of the side core plates. Because the surface of the side core plates may be made a flat surface, the assembling property of the rotor for electric motor can be improved, and miniaturization of the rotor for electric motor can be realized.

Furthermore, since the radial protrusion portions of the non-magnetic body are formed to cover at least one portion of the engaging convexes and the engaging holes, the fixing force to the non-magnetic body and the rotor core can be improved.

According to a twelfth aspect of the present invention, in the rotor for electric motor of any one of the first to eleventh aspects of the present invention, a length of the magnet in the axial direction is set to be longer than a length of the rotor core in the axial direction. Both ends of the magnets in the axial direction respectively protrude from both ends in the axial direction of the rotor core.

By the configuration described above, both ends of the magnets can pass through the inner circumferential side of the linking portions of the side core plates. Therefore, the magnets can be more reliably prevented from coming outward in the radial direction by the linking portions of the side core plates.

According to a thirteenth aspect of the present invention, the rotor for electric motor of any one the first to twelfth aspects of the present invention is the rotor cores is configured to be stacked in multiple stages in the axial direction.

By the configuration described above, the length of the entire rotor core in the axial direction may be freely set according to the specification of the motor.

According to a fourteenth aspect of the present invention, a brushless motor of the present invention includes the rotor for electric motor according to any one of the first to thirteenth aspects of the present invention; a motor case, rotatably supporting the rotor; and a stator, fixed inside the motor case, and wound by a winding wire supplied with a current.

By the configurations as described above, a brushless motor with little leakage magnetic flux and high performance can be obtained.

### Effect

According to the rotor for electric motor and the brushless motor, the leakage magnetic flux on the inner circumference portion of the rotor core can be significantly reduced, and the rotor core can be held tightly on the rotary shaft.

### BRIEF DESCRIPTION OF THE DRAWINGS

FIG. 1 is a longitudinal cross-sectional view of a brushless motor according to an embodiment of the present invention.

FIG. 2 is a side view of a rotor for electric motor according to an embodiment of the present invention.

FIG. 3 is a perspective view when a rotor according to an embodiment of the present invention is viewed from one side in an axial direction.

FIG. 4 is a perspective view when a rotor according to an embodiment of the present invention is viewed from the other side in an axial direction.

FIG. 5 is an exploded perspective view and an assembly perspective view of a rotor according to an embodiment of the present invention.

FIG. 6 is an exploded perspective view and an assembly perspective view of a core unit configuring a rotor according to an embodiment of the present invention.

FIG. 7 is an exploded perspective view and an assembly perspective view of a rotor core configuring a rotor according to an embodiment of the present invention.

FIG. 8A is an explanation drawing of magnet guiding projections of divided cores forming a rotor according to an embodiment of the present invention, and a perspective view of a state that side core plates are removed.

FIG. 8B is an explanation drawing of magnet guiding projections of divided cores forming a rotor core according to an embodiment of the present invention, and a perspective view showing a state that the side core plates are attached to make a relationship between sizes of magnet guiding projections and linking portions of side core plates understood.

FIG. 9 is a perspective view showing a relationship between a rotor core and a rotary shaft according to an embodiment of the present invention.

FIG. 10A is a cross-sectional view in an axial direction showing a relationship between a rotor core and a rotary shaft according to an embodiment of the present invention, and shows a state before a molded resin is filled.

FIG. 10B is a cross-sectional view in an axial direction showing a relationship between a rotor core and a rotary shaft according to an embodiment of the present invention, and shows a state after a molded resin is filled.

FIG. 11 is an enlarged section view of a main portion showing a relationship between a rotary shaft, protrusions of divided cores and a molded resin according to an embodiment of the present invention.

FIG. 12A is a perspective view showing a state when a rotary shaft and a rotor core according to an embodiment of the present invention are coupled by a molded resin.

FIG. 12B is a front view observed from an arrow E1 direction in FIG. 12A.

FIG. 12C is a front view observed from an arrow E2 direction in FIG. 12A.

FIG. 13 is a perspective view showing a state when a rotor is about to be completed by inserting magnets into an assembly in a state shown in FIG. 12.

FIG. 14 is a perspective view observed from a side opposite to FIG. 13.

FIG. 15 is a perspective view of side core plates of a variation of an embodiment of the present invention.

### DESCRIPTION OF THE EMBODIMENTS

Next, embodiments of the present invention are described based on drawings.

### (Brushless Motor)

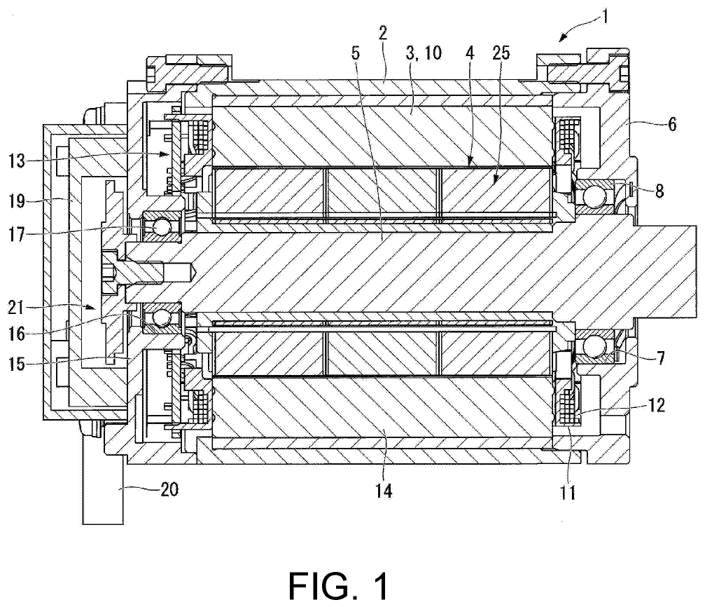

FIG. 1 is a longitudinal cross-sectional view of a brushless motor according to an embodiment.

As shown in FIG. 1, the brushless motor 1 is a so-called inner rotor type motor. The brushless motor 1 includes a stator 3 that is pressed into a stator housing (motor case) 2, and a rotor 4 that is arranged rotatably with respect to the stator housing 2 in the inside of the stator 3 in a radial direction.

The stator housing 2 is formed into a tubular shape, and the stator 3 is pressed into an inner circumference of the tubular part. One end of a rotary shaft 5 of the rotor 4 is exposed from one side of the stator housing 2 (the right end side in FIG. 1).

Furthermore, in the following description, a protrusion side of the rotary shaft 5 (the right side in FIG. 1) is referred to one side, and the opposite side (the left side in FIG. 1) is referred to the other side. In addition, in the following description, the axial direction of the rotary shaft 5 is simply referred to an axial direction, the radial direction of the rotary shaft 5 is simply referred to a radial direction, and the rotating direction of the rotary shaft 5 is referred to a circumferential direction.

The one side of the stator housing 2 is blocked with a first bracket 6 that is formed into a substantially disk shape. A first bearing support hole 7 is formed in the center of the first bracket 6 in the radial direction. A first bearing 8 that supports the rotary shaft 5 is pressed in and fixed into the first bearing support bore 7.

The stator 3 has a stator core 10 with a substantially cylindrical shape. An outer circumferential surface of the stator core 10 is fixed to an inner circumference of the stator housing 2 by pressing for example. The stator core 10 is provided with multiple teeth 14 to protrude to facing an inner side in the radial direction at equal intervals in the circumferential direction. A coil 12 is wound via an insulator 11 on the teeth 14. Furthermore, the stator core 10 is formed by stacking a plurality of pieces of steel sheet materials in a lamination form.

End portions of the coil 12 wound on each tooth 14 are extracted toward the other side of the stator housing 2. Then, the end portions of the coil 12 are connected to a printed circuit board 13 that is provided on the other side of the stator housing 2.

The printed circuit board 13 appropriately connects each end portion of the coil 12, and supplies electric power from the outside to the coil 12. The printed circuit board 13 is printed with a conductive wiring pattern that is connected to the prescribed end portions of the coil 12.

In addition, the printed circuit board 13 is connected to one end side of a terminal (not shown in the drawings). The printed circuit board 13 is exposed in the inside of a power connector 20 where the other side of the terminal is provided on the outer circumference portion of the stator housing 2.

A second bracket 15 that blocks the other side of the stator housing 2 is provided on the other side of the printed circuit board 13. The second bracket 15 is formed into a substantially disk shape, and a second bearing support hole 16 is formed at the center. A second bearing 17 which rotatably supports an end portion on the other side of the rotary shaft 5 is pressed in and fixed to the second bearing support hole 16. Furthermore, the end portion on the other side of the rotary shaft 5 is covered by a third bracket 19 that is fixed to the second bracket 15.

Furthermore, although a detailed description is omitted, the brushless motor 1 has, for example, a magnetic encoder 21 that detects a rotation position of the rotor 4. Furthermore, a detection means for detecting the rotation position of the rotor 4 may be an optical configuration.

(Rotor)

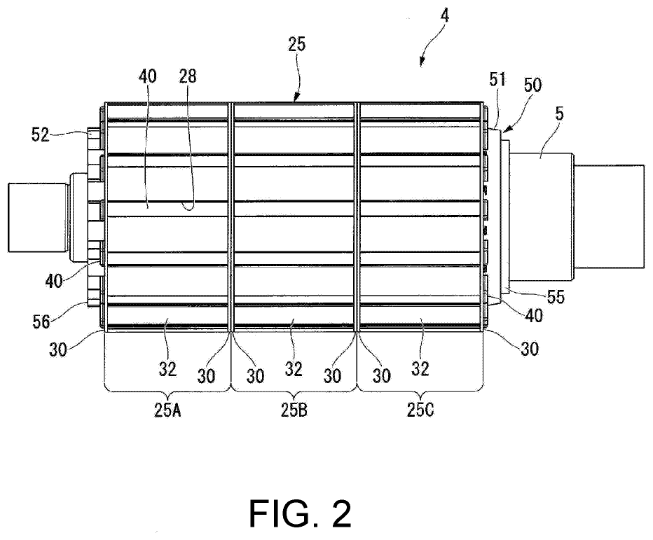

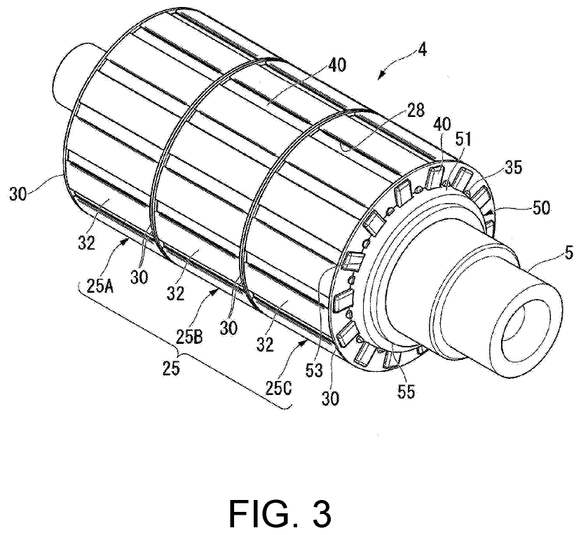

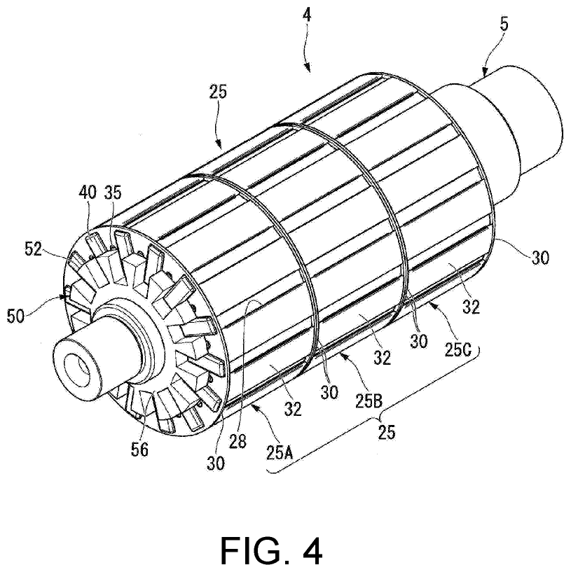

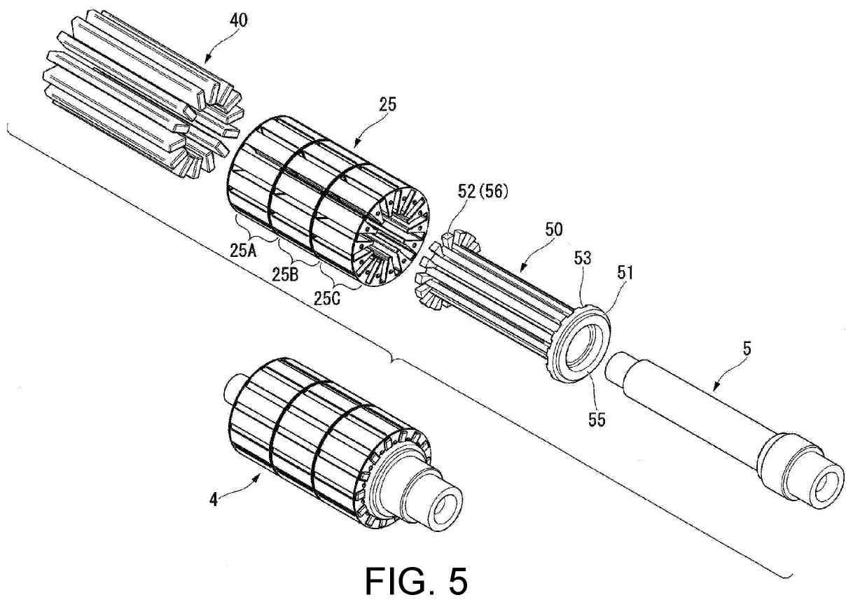

FIG. 2 is a side view of the rotor 4 for electric motor applicable to the brushless motor 1. FIG. 3 is a perspective view observing the rotor 4 from one side of the axial direction. FIG. 4 is a perspective view observing the rotor 4 from the other side of the axial direction. FIG. 5 is an exploded perspective view and an assembled perspective view of the rotor 4.

As shown in FIGS. 2-5, the rotor 4 for electric motor comprises a metallic rotary shaft 5; a rotor core 25 (25A, 25B, 25C) that is made of a magnetic body and is fixed on an outer-circumference of the rotary shaft 5, multiple magnets 40 that are radially provided with prescribed intervals inside the rotor core 25 along the circumferential direction; and a molded resin (a non-magnetic body) 50 that is filled and solidified between the rotary shaft 5 and the rotor core 25 to couple the rotary shaft 5 and the rotor core 25. Furthermore, the rotary shaft 5 may be formed by a non-magnetic body such as an aluminum sintered material or a SUS304, or be formed by iron and so on that are magnetic body.

(Rotor Core)

The rotor core 25 is configured to link core units (rotor core 25) 25A, 25B, 25C of the same shape in the axial direction in one stage or multiple stages (three stages in this example). Furthermore, in the following description, in order to make the description easier to understand, distinctions are made in the description in a way that the object obtained by stacking each rotor core 25A-25C is referred to the rotor core 25, and each individual rotor core 25A-25C is respectively referred to core units 25A, 25B, 25C. However, the rotor core 25 may be formed by at least one unit, by one unit, or by multiple stages as long as the whole can function as the rotor core 25.

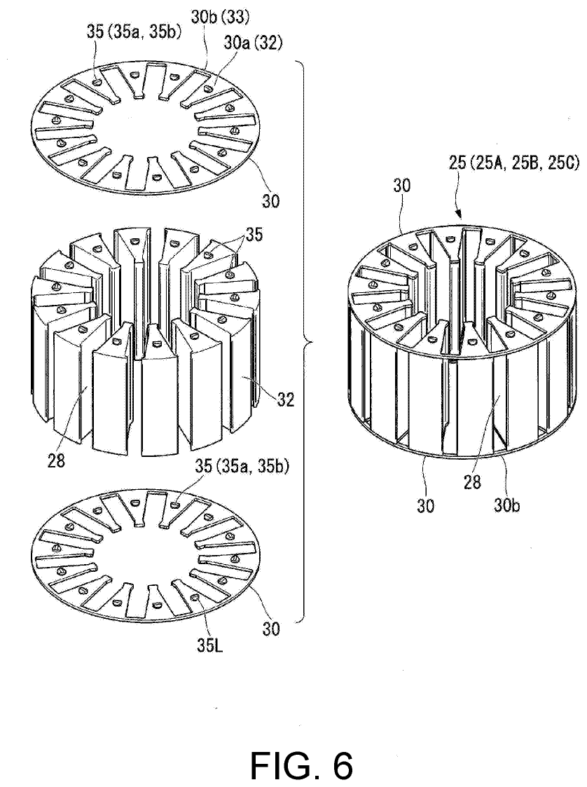

FIG. 6 is an exploded perspective view and an assembly perspective view of the core units 25A, 25B, 25C, and is an exploded perspective view and an assembled perspective view of the rotor core 25.

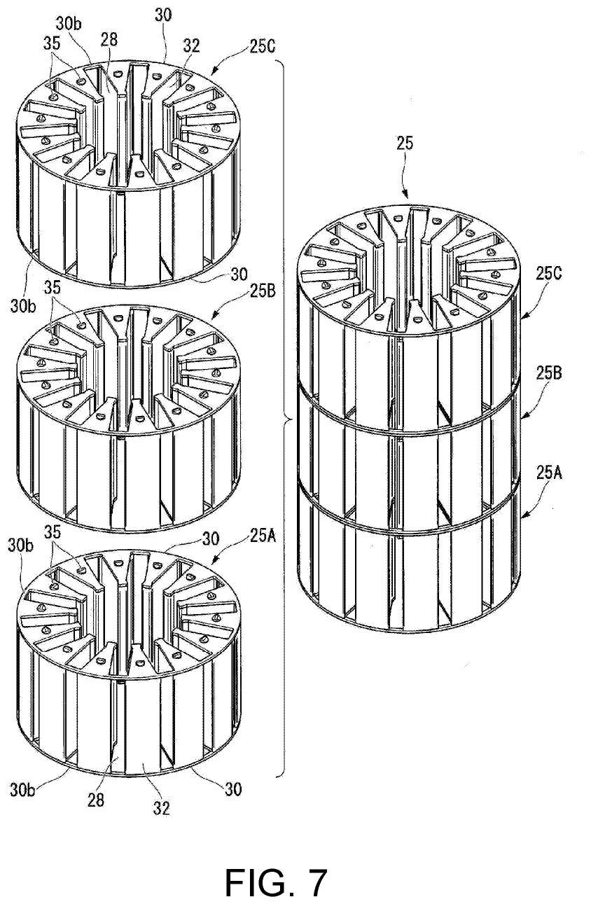

As shown in FIGS. 6 and 7, the rotor core 25 includes a plurality of divided cores 32 that form magnetic pole portions of the rotor side, which face and magnetically couple to the magnetic poles (teeth) of the stator 3 side. In addition, the rotor core 25 includes a plurality of slits 28 that are positioned among the divided cores (magnetic poles) 32 and extend in the radial direction and the axial direction. The multiple slits 28 are radially arranged with prescribed intervals in the circumferential direction and are centered at the rotary shaft 5.

The rotor core 25 is configured to laminate a plurality of electromagnetic steel sheets (steel sheet materials), which are magnetic bodies, in the axial direction. The laminated electromagnetic steel sheets are mutually linked with one another by the engagement of concave-convex portions 35 (convex portions 35a and concave portions 35b) which are respectively formed on a lamination surface. The concave-convex portions 35 are formed by, for example performing the press processing to the electromagnetic steel sheets.

Each core unit 25A, 25B, 25C is configured to include the plurality if divided cores 32 that are arranged with prescribed intervals in the circumferential direction and are sectorial shape as viewing from the axial direction, and side core plates 30 that serve as linking members. The side core plates 30 are respectively made of one piece of electromagnetic steel sheet, and are respectively provided on both end portions in the axial direction of the laminated steel sheet materials. Here, in order to prevent a magnetic flux of an outer-circumferential portion of the rotor core 25 from wrapping around, the side core plates 30 is formed by one piece of electromagnetic steel sheet that is the minimum piece required for the strength. The divided cores 32 and the side core plates 30 are also coupled by the engagement of the concave-convex portions 35 (the convex portions 35a and the concave portions 35b) that are formed on superposition surfaces of the divided cores 32 and the side core plates 30. The concave-convex portions 35 are also formed, for example, by performing the press processing to the electromagnetic steel sheets.

(Divided Core)

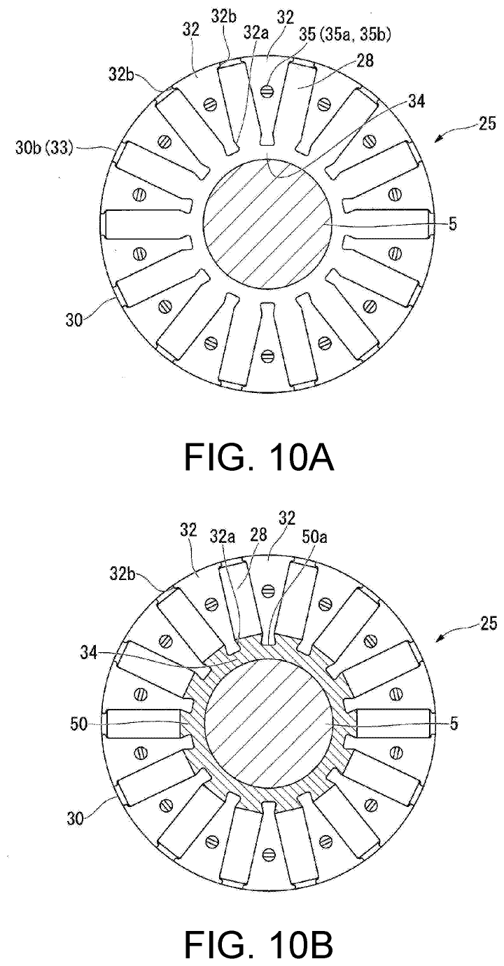

As shown in FIG. 6, the divided cores 32 are provided to be separated from one another as portions that respectively form the magnetic pole portions of the rotor side. In addition, the divided cores 32 are arranged with prescribed intervals in the circumferential direction in a state that the slits 28 are maintained between the divided cores adjacent in the circumferential direction, and as shown in FIGS. 10A and 10B, a void portion 34 is maintained between the respective inner-circumferential ends of the divided cores and the outer-circumference of the rotary shaft 5.

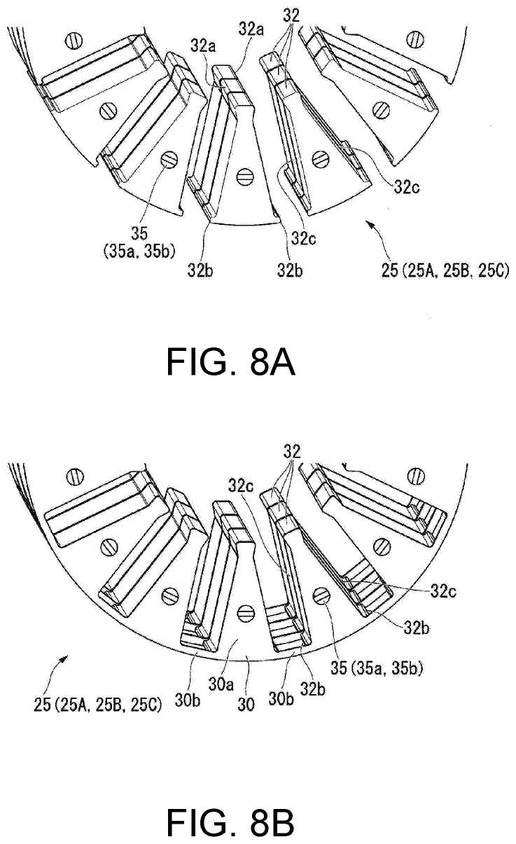

FIGS. 8A and 8B are drawings for explaining the magnet guiding projections 32b of the divided cores 32 in the rotor core 25. FIG. 8A is a perspective view of the rotor core 25 in a state that the side core plates 30 are removed, and FIG. 8B is a perspective view of rotor core 25 showing a state that the side core plates 30 are attached to understand the relationship between sizes of the magnet guiding projections 32b and the linking portions 30b of the side core plates 30. FIGS. 10A and 10B are cross-sectional views in the axial direction showing a relationship between the rotor core 25 and the rotary shaft 5. FIG. 10A shows a state before the molded resin (non-magnetic body) 50 is filled, and FIG. 10B shows a state after the molded resin (non-magnetic body) 50 is filled.

As shown in FIG. 8A and FIG. 10A, each divided core 32 that is formed in a sectorial shape viewing from the axial direction has protrusions 32a on both sides in the circumferential direction of each inner-circumferential end where the circumferential width gets narrower. The protrusions 32a are formed to be a dovetail projection shape, and the ends widen slightly toward the inner side of the radial direction. Furthermore, an inner circumferential end surface of each divided core 32 is formed into a flat surface perpendicular to a center line of the circumferential width of the divided cores 32 which passes through the center of the rotary shaft 5. Accordingly, the leakage magnetic flux from the inner-circumferential end surface is efficiently reduced.

In addition, each divided core 32 has magnet guiding projections 32b that guide an insertion when the magnets 40 are inserted in the slits 28 along the axial direction on both sides in the circumferential direction at the outer-circumferential ends where the circumferential width gets wider. The magnet guiding projections 32b are formed to protrude along the circumferential direction from the outer circumferential ends on both sides 32c of the divided cores 32. Then, a width between the magnet guiding projections 32b that face each other with the slit 28 there between is set to be smaller than a width in the circumferential direction of the outer circumferential ends of the magnets 40 that are provided in the inner circumferential side of the magnet guiding projections 32b.

In addition, as shown in FIG. 8B, the magnet guiding projections 32b are formed with a size that falls within the projection surface of the linking portions 30b (described later) of the side core plates 30 when the rotor core 25 is viewed from the axial direction.

(Side Core Plates)

As shown in FIG. 6, the side core plates 30 function as the linking members that link the outer circumferential ends of the plurality of divided cores 32 in the circumferential direction, in which the divided cores 32 are arranged in the circumferential direction. The side core plates 30 are arranged and fixed on both ends of the divided cores 32 in the axial direction.

Each side core plate 30 integrally includes, on one piece of the plate, divided core equivalent portions (core piece bodies) 30a that overlap with the divided cores 32 in the axial direction, and arc-shaped linking portions 30b. In the circumferential direction, the linking portions 30b link the outer circumferential ends of the divided cores 32 provided to be separated from one another by connecting the outer circumferential ends of the divided core equivalent portions 30a that are arranged in positions across the slits 28 and are adjacent in the circumferential direction. Then, the concave-convex portions 35 (the convex portions 35a and the concave portions 35b), which couple the divided cores 32 and the side core plates 30, are formed on the divided core equivalent portions (core piece bodies) 30a by, for example, boss processing.

(Magnets)

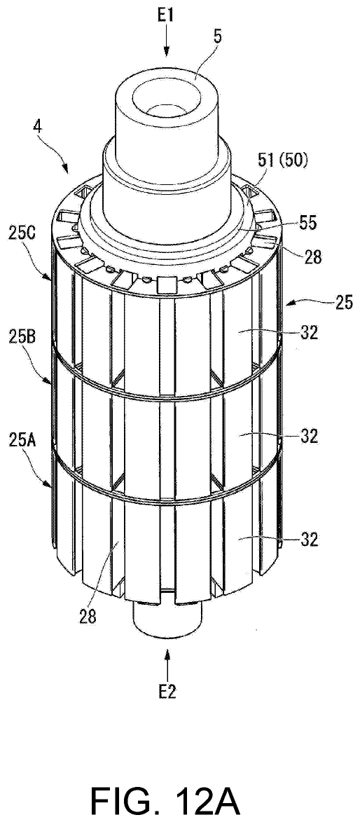

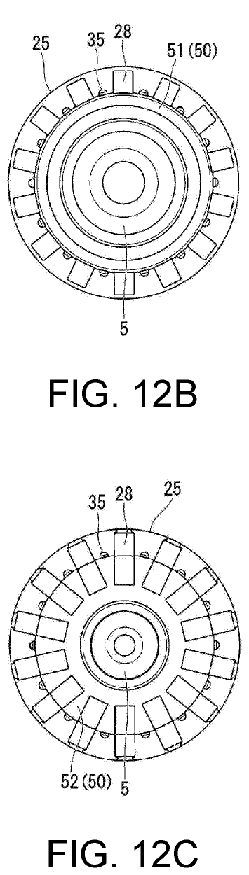

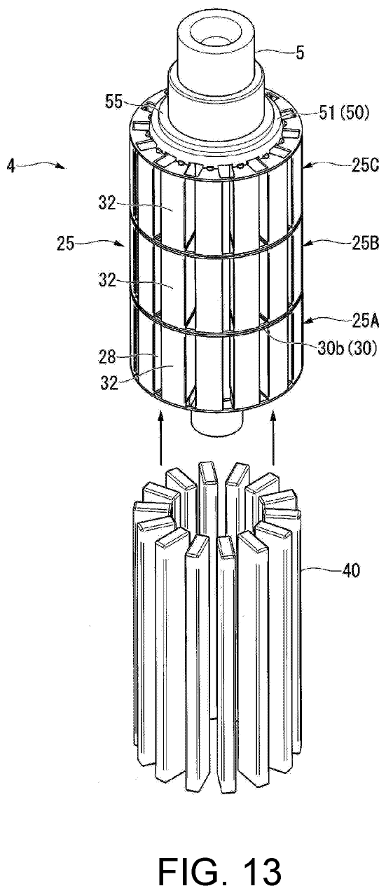

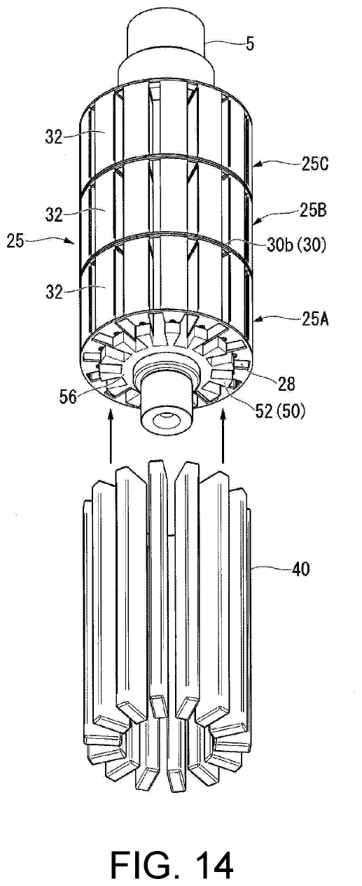

FIG. 13 is a perspective view showing a state that the rotor 4 is about to be completed by inserting the magnets 40 in an assembly in a state shown in FIGS. 12A-12C, and FIG. 14 is a perspective view observed from one side opposite to FIG. 13.

As shown in FIG. 13 and FIG. 14, the magnets 40 are permanent magnets that are made of segment-type neodymium and so on, having cross-sections viewed from the axial direction that are formed in rectangle blocks. The magnets 40 are inserted into each slit 28 of the rotor core 25 from the axial direction. The magnets 40 are magnetized respectively in the circumferential direction of the rotary shaft 5, and are arranged in a manner that the same magnetic pole faces each other between slits 28 adjacent in the circumferential direction. Then, by magnetic field lines generated by the adjacent magnets 40, the divided cores 32 (magnetic pole portions) between magnets 40 that are arranged side by side in the circumferential direction are mutually magnetized into different polarity. In this way, the rotor 4 can efficiently generate the motor torque.

A length of the magnets 40 is set to be slightly longer than a length of the rotor core 25 in the axial direction. As shown in FIG. 2-FIG. 4, the magnets 40 accommodated in the slits 28 pass through, in the axial direction, the inner circumferential side of the linking portions 30b of the side core plates 30 of each core unit 25A, 25B, 25C. Both ends of the magnets 40 in the axial direction pass through, in the axial direction, the inner circumferential side of the linking portions 30b of the side core plates 30 that are placed on both ends of the rotor core 25 in the axial direction. In this way, both ends of the magnets 40 in the axial direction slightly protrudes so that the protrusion amount from both end surfaces of the rotor core 25 in the axial direction toward the outside of the axial direction is the same.

(Molded Resin)

The molded resin (non-magnetic body) 50 that is a non-magnetic body is filled between the rotor core 25 and the rotary shaft 5. Specifically, as shown in FIG. 10B, the molded resin 50 covers the void portion 34 between the inner circumferential end of the rotor core 25 and the outer circumference of the rotary shaft 5 and the protrusions 32a at the inner-circumferential end of each divided core 32, and is filled to a position that defines the inner circumferential ends of the slits 28. In this way, the rotor core 25 and the rotary shaft 5 are integrally coupled by the molded resin 50.

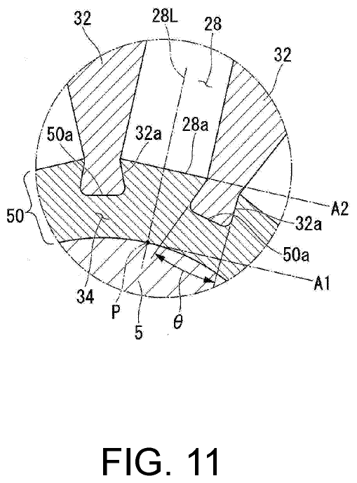

Here, as shown in FIG. 10B and FIG. 11, the molded resin 50 is formed to bury the protrusions 32a of the inner circumferential end of each divided core 32. Therefore, as a result, the molded resin 50 is engaged with a groove 50a that receives the protrusions 32a and is engaged with the protrusions 32a. Therefore, the groove 50a is formed into a dovetail groove shape. In this way, the dovetail projection shaped protrusions 32a of each divided core 32 are engaged with the dovetail groove shaped groove 50a. Therefore, each divided core 32 (rotor core 25) is prevented from separating from the molded resin 50 toward the outside of the radial direction.

Furthermore, a widening angel θ of the protrusions 32a and the groove 50a may be an angel as long as the protrusions 32a can be prevented from falling from the groove 50a toward the outside of the radial direction, and is desirably as close to 0° as possible. As the angle gets close to 0°, the protrusions 32a and the groove 50a get close to a straight shape (cross-section is a rectangular shape). Therefore, a distance between the adjacent protrusions 32a in the circumferential direction becomes long, and the leakage of the magnetic flux through the protrusions 32a can be extremely suppressed.

In addition, as shown in FIG. 2-FIG. 5, the molded resin 50 has protrusion portions 55, 56 which protrudes in axial direction toward the outside of two end surfaces in the axial direction of the rotor core 25. Each protrusion portion 55, 56 respectively has radial protrusion portions 51, 52, and the radial protrusion portions 51, 52 are of a flange shape that protrude toward the outside of the radial direction to cover a portion of the two end surfaces in the axial direction of the rotor core 25.

As shown in FIG. 3, FIG. 5, FIG. 12A, FIG. 12B, and FIG. 13, in the two radial protrusion portions 51, 52, the radial protrusion portion 51 on one side extends in the radial direction of the end surfaces in the axial direction of the rotor core 25, to a position that covers a portion of the slits 28. Particularly, the radial protrusion portion 51 on this side has a plurality of positioning recesses 53, corresponding to each slit 28, that position the end portions in the axial direction of the magnets 40 protruding from the end portions in the axial direction of the rotor core 25.

In addition, as shown in FIG. 4, FIG. 12C and FIG. 14, the radial protrusion portion 52 on the other side extends, avoiding the slits 28, in the radial direction of the end surfaces in the axial direction of the rotor core 25.

The divided cores 32 and the side core plates 30 are mutually linked by the engagement of the concave-convex portions 35 that are formed on the superposition surfaces of the divided cores 32 and the side core plates 30. Then, the radial protrusion portions 51, 52 on one side and the other side are provided to cover a portion of at least one of the concave-convex portions 35 (the convex portions 35a or the concave portions 35b) of the side core plates 30.

(Rotor Assembly)

Next, an assembling procedure of the rotor 4 is described.

When assembling the rotor 4, as shown in FIG. 6, at first, the divided cores 32 of a required number are prepared. Each divided core 32 is formed by laminating prescribed pieces of electromagnetic steel sheets that are press processed into a prescribed shape. In addition, the side core plates 30 are laminated on both ends in the axial direction so as to hold the divided cores 32 therebetween, while the divided cores 32 of the required number are arranged with prescribed intervals in the circumferential direction. Then, the divided cores 32 and the side core plates 30 are coupled. In this way, the core units 25A, 25B, 25C are completed. By assembling in this way, the slits 28 where the magnets 40 are to be inserted may be secured between the divided cores 32 of each core unit 25A, 25B, and 25C.

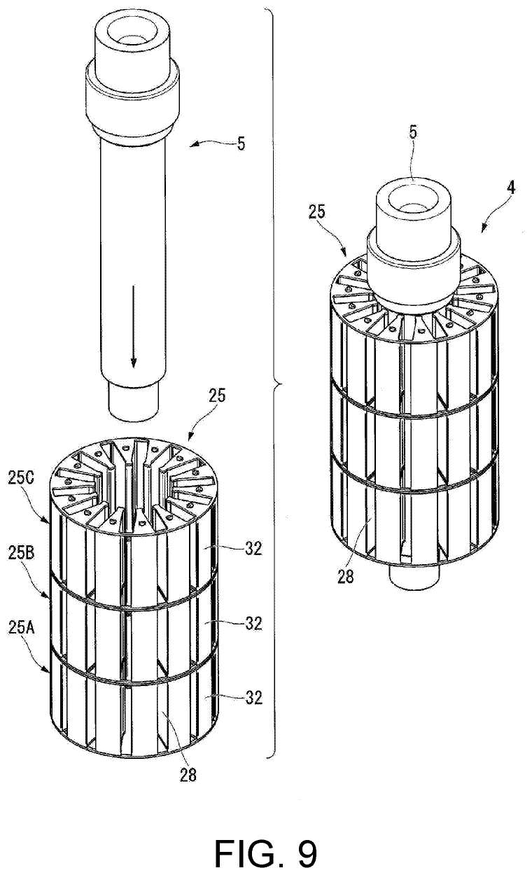

Next, as shown in FIG. 7, the rotor core 25 is assembled by linking the core units 25A, 25B, 25C of the required number in a multistage stacking shape in the axial direction. Then, as shown in FIG. 9, the rotary shaft 5 is inserted into a space in the center of the assembled rotor core 25, the rotary shaft 5 and the rotor core 25 are set into a mold (not shown in drawings) for injection molding the molded resin 50 while a prescribed position relationship is maintained.

As shown in FIG. 10A, in the setting stage, the void portion 34 is maintained between the inner circumferential ends of each divided core 32 of the rotor core 25 and the outer circumference of the rotary shaft 5. Then, melted molded resin materials are filled into the mold, and as shown in FIG. 10B, the molded resin 50 is filled to cover the void portion 34 and the protrusions 32a at the inner circumferential ends of each divided core 32, and to a position that defines the inner circumferential ends of the slits 28.

At this time, as shown in FIG. 11, due to the shape of the mold, the inner circumferential end surfaces 28a of the slits 28 formed by the molded resin 50 are formed into flat surfaces perpendicular to a center line 28L that passes through a center of the circumferential width of the slits 28 and a shaft center of the rotary shaft 5. In this way, a line A2 drawn from the inner circumferential end surfaces 28a of the slits 28 is parallel to a tangential line A1 of the rotary shaft 5 at a point P where the center line 28L of the circumferential width of the slits 28 intersects the outer circumference of the rotary shaft 5.

By molding the molded resin 50 in this way, an intermediate product of the rotor core having the slits 28 as shown in FIG. 14 is completed. In this stage, the radial protrusion portion 51 on one side of the molded resin 50 blocks a portion of the end surfaces in the axial direction of the slits 28, and the radial protrusion portion 52 on the other side of the molded resin 50 is formed on the position avoiding the slits 28.

Next, as shown in FIG. 13 and FIG. 14, the plurality of magnets 40 are respectively inserted into each slit 28 of the intermediate product of the rotor core from the other side, namely the side of the radial protrusion portion 52 that is formed to avoid the slits 28. At this time, since the magnet guiding projections 32b are provided on both side surfaces 32c of the divided cores 32, the insertion of the magnets 40 becomes easy by inserting the magnets 40 into the slits 28 along the magnet guiding projections 32b. In addition, an axial position is defined so that the protrusion amount of the magnets 40 from both end surfaces of the rotor core 25 in the axial direction is the same, in which magnets 40 are inserted by the positioning recesses 53 provided on the radial protrusion portion 51.

The rotor 4 as shown in FIG. 2-FIG. 4 is completed by the process above.

### Effect of the Embodiment

In this way, in the embodiments described above, each divided core 32 that forms the magnetic pole portions of the rotor 4 is separated from one another in the circumferential direction, and the inner circumferential side of each divided core 32 is linked to the rotary shaft 5 through the molded resin 50. Furthermore, since the void portion 34 is maintained between the inner circumferential end of each divided core 32 and the outer circumference of the rotary shaft 5, each divided core 32 is respectively provided in an isolation state. Therefore, the leakage magnetic flux on the inner circumference portion of the rotor core 25 can be significantly reduced.

In addition, the rotor core 25 and the rotary shaft 5 are integrally coupled by the filled molded resin 50. Therefore, the rotor core 25 can be held easily and tightly. Particularly the protrusions 32a at both circumferential ends of the inner circumferential ends of each divided core 32 and the grooves 50a of the molded resin 50 are engaged. Therefore, the falling of each divided core 32 (the rotor core 25) outward in the radial direction is restricted, and a holding strength of the rotor core 25 can be highly maintained.

In addition, since the rotary shaft 5 and the rotor core 25 can be coupled by one process of filling the molded resin 50, reduction of the production cost is realized. In addition, since the void portion 34 between the rotor core 25 and the rotary shaft 5 is buried by the molded resin 50, the diameter of the rotary shaft 5 can be reduced. For example, since the rotor core 25 can be firmly held even when the shaft diameter is small, effectiveness can be exhibited when the shaft diameter is small. In addition, since the molded resin 50 is filled to the position that defines the inner circumferential ends of the slits 28, the position of the inner circumferential ends of the magnets 40 can be determined by the molded resin 50. As a result, an amount of the magnetic flux generated on the outer circumferential surface of the rotor core 25 can be uniformed over the entire periphery of the rotor core 25.

In addition, the rotor core 25 is formed by the plurality of divided cores 32 and the side core plates 30 that are provided on both axial ends of the divided cores 32. Furthermore, the side core plates 30 are formed by the divided core equivalent portions (core piece bodies) 30a overlapping with the divided cores 32 in the axial direction, and the arc-shaped linking portions 30b that link the outer circumferential ends of the divided cores 32 in the circumferential direction. Therefore, an integral rotor core 25 can be simply formed while using the divided cores that are separated. In addition, the holding force of the magnets 40 by the rotor core 25 can be maintained even when the divided cores 32 are used.

In addition, the length of the magnets 40 is set to be slightly longer than the length of the rotor core 25 in the axial direction. Then, both ends of the magnets 40 pass through the inner circumferential sides of the linking portions 30b of the side core plates 30. Therefore, the magnets 40 can be prevented from coming outward in the radial direction by the linking portions 30b of the side core plates 30.

Furthermore, the rotor core 25 is formed by laminating the plurality of electromagnetic steel sheets in the axial direction, and the side core plates 30 are each made by one piece of electromagnetic steel sheet provided on both axial ends among the laminated electromagnetic steel sheets. Therefore, except the side core plates 30 that are positioned on end portions in the axial direction, there is no portion (linking portion 30b) connecting the divided cores 32, which are separated from one another, in the circumferential direction. As a result, the leakage magnetic flux of the rotor core 25 can be minimized.

In addition, the laminated steel sheet materials are linked with each other by the engagement of the concave-convex portions 35 (convex portions 35a and the concave portions 35b) that are formed on the respective lamination surface. Therefore, the rotor core 25 can be inexpensively made by laminating prescribed pieces of the electromagnetic steel sheets that are press processed into a prescribed shape. In addition, it can easily correspond to the motor specifications by adjusting the laminated pieces of the electromagnetic steel sheets.

In addition, the linking portions 30b that connect the divided cores 32 with one other are provided on the side core plates 30, and the magnet guiding projections 32b are provided on both sides of the outer circumferential ends of each divided core 32 in the circumferential direction. Therefore, the magnets 40 are easily inserted into each slit 28, and an improvement of the assembling property of the magnets 40 can be realized. In addition, the width between the magnet guiding projections 32b that face each other with the slit 28 therebetween is set to be smaller than the circumferential width of the outer circumferential ends of the magnets 40 that are provided on the inner circumferential side of the magnet guiding projections 32b. Therefore, there is an additional effect of preventing the magnets 40 from coming outward in the radial direction.

In addition, the magnet guiding projections 32b are formed into a size that falls within the projection surface of the linking portions 30b of the side core plates 30 when the rotor core 25 is viewed from the axial direction. Therefore, when the magnets 40 are inserted into the slits 28 of the rotor core 25 along the axial direction, the magnets 40 can be smoothly inserted by being guided into the linking portions 30b.

In addition, the radial protrusion portion 52 on the other side, which is one of the pair of the radial protrusion portions 51, 52 of the molded resin 50, extends in the radial direction of the end surface of the rotor core 25 avoiding the slits 28. Therefore, an insertion entrance of the magnets 40 to the slits 28 can be maintained after the molded resin 50 is filled.

Furthermore, the radial protrusion portion 51 on one side extends in the radial direction of the axial end surfaces of the rotor core 25 to the position that covers a portion of the slits 28. Therefore, the positioning of the magnets 40 inserted into the slits 28 in the axial direction can be made. Particularly, since the positioning recesses 53 are provided on the radial protrusion portion 51 on one side, the positioning of the magnets 40 can be easily and correctly made. In addition, the magnets 40 can also be prevented from coming outward in the radial direction.

In addition, the radial protrusion portions 51, 52 of the molded resin 50 are provided to cover a portion of the concave-convex portions 35 that link the side core plates 30 and the divided cores 32. Therefore, the rotor core 25 configured by linking the plurality of core units 25A, 25B, 25C is separated again is suppressed, and an improvement of a fixing force of the molded resin 50 and the rotor core 25 is realized.

Furthermore, the rotor core 25 is configured by stacking multiple stages of the core units 25A, 25B, 25C, which are configured by multiple divided cores 32 and side core plates 30, in the axial direction. Therefore, the number of the stages of the core units 25A, 25B, 25C and the length of the rotor core 25 can be freely set according to the specifications of the motor.

Furthermore, the present invention is not limited to the embodiments above, and includes variations in which various modifications are added to the embodiments without departing from the scope of the present invention.

For example, if a knurling process is performed on the outer circumference of rotary shaft 5, the jointing strength of the molded resin 50 and the rotary shaft 5 can be further improved.

In addition, in the embodiments described above, a case that the molded resin 50 is used as a means of linking the rotary shaft 5 and the rotor core 25 is described. However, the present invention is not limited thereto, various non-magnetic bodies can be used instead of the molded resin 50. For example, non-magnetic metal materials such as aluminum and so on can also be used. Even when the molded resin 50 is not used, the rotary shaft 5 and the rotor core 25 can be reliably linked by arranging the protrusions 32a on the rotor core 25 and arranging the grooves 50a in the non-magnetic body.

Furthermore, in the embodiments described above, a case that the shape of the protrusions 32a and the grooves 50a are dovetail shape is described. However, the present invention is not limited thereto, and any shape may be satisfied as long as the protrusions 32a do not fall outward in the radial direction when the protrusions 32a and the grooves 50a are engaged (fitted). For example, it may be that the protrusions 32a have a shape with flange, and the grooves 50a are formed correspond to such flange shape.

In addition, in the embodiments described above, a case that the rotor core 25 is configured by the divided cores 32 is described. However, the present invention is not limited thereto, and the rotor core 25 may be an integral rotor core 25 in which each divided core 32 is linked on the inner circumferential side. Even though in this occasion, if the void portion 34 is formed between the inner circumferential side of the rotor core 25 and the rotary shaft 5, the leakage of the magnetic flux on the rotary shaft 5 can be prevented. As a result, the leakage magnetic flux is reduced for the entire rotor core 25.

Furthermore, in the embodiments described above, a case that the magnet guiding projections 32b are formed to protrude along the circumferential direction from the outer circumferential ends on both side surfaces 32c of the divided cores 32 is described. However, the present invention is not limited thereto, and the magnet guiding projections 32b may be arranged on at least one of the two side surfaces 32c of the divided cores 32. On this occasion, the magnet guiding projections 32b are desirably provided to be located in each slit 28.

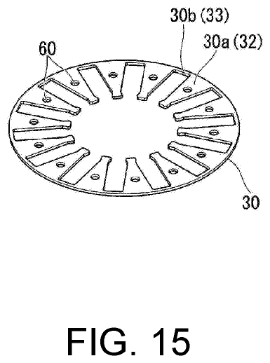

In addition, in the embodiments described above, a case is described that the concave-convex portions 35 are formed on each divided core 32 and are also formed on the side core plates 30 forming each core unit 25A, 25B, 25C, and each divided core 32 and each side core plate 30 are linked using the concave-convex portions 35. However, the present invention is not limited thereto. As shown in FIG. 15, instead of the concave-convex portions 35, through holes 60 may be formed on the side core plates 30 that are linked at the side of the protrusions 35a of the divided cores 32.

Accordingly, by fitting the concave-convex portions 35 (protrusions 35a) of each divided core 32 to the through bores 60 of the side core plates 30, the protrusions are not formed on a surface of the side core plates 30. Therefore, the surface of the side core plates 30 can be a flat surface. Even when viewed as the assembled core units (rotor cores 25) 25A, 25B, 25C, the protrusions are not formed on both end surfaces in the axial direction. Then, the assembling property of the rotor 4 can be improved and the downsizing of the rotor 4 can be realized accordingly.

### INDUSTRIAL APPLICABILITY

According to the rotor for electric motor and the brushless motor described above, the leakage magnetic flux in the inner circumference portion of the rotor core can be substantially reduced, and the rotor core can be tightly kept on the rotary shaft.

### DESCRIPTION OF THE SYMBOLS

1 brushless motor
2 stator housing (motor case)
3 stator
4 rotor (rotor for electric motor)
5 rotary shaft
12 coil (winding wire)
25 rotor core
25A core unit (rotor core)
25B core unit (rotor core)
25C core unit (rotor core)
28 slit
30 side core plate
30a divided core equivalent portion (core piece body)
30b linking portion
32 divided core
32a protrusion
32b magnet guiding projection
32c side surface
34 void portion
35 concave-convex portion (projection, engaging projection, concave portion)
35a convex portion (projection, engaging projection)
35b concave portion (engaging concave)
40 magnet
50 molded resin (non-magnetic body)
50a groove
51 radial protrusion portion
52 radial protrusion portion
53 positioning recess
60 through hole (engaging hole)

1. A rotor for electric motor, comprising:
a rotary shaft;
a non-magnetic body, formed to cover an outer circumferential surface of the rotary shaft;
a rotor core, linked to the outer circumference of the rotary shaft through the non-magnetic body, and a plurality of slits that extend in an axial direction and a radial direction of the rotary shaft being formed side by side along a circumferential direction of the rotary shaft; and
a plurality of magnets, provided in the plurality of the slits,
wherein the rotor core is formed in a manner that there is a space between an inner circumferential surface side of the rotor core and the outer circumferential surface of the rotary shaft, and
protrusions are provided on an inner circumferential side of the rotor core to suppress the rotor core from being separated from the non-magnetic body outward in the radial direction, and grooves are provided on the non-magnetic body to receive the protrusions and engage with the protrusions.

2. The rotor for electric motor according to claim 1, wherein the rotor core comprises:
a plurality of divided cores, extending in the axial direction and the radial direction, and are arranged radially on the outer circumferential surface of the rotary shaft; and
a side core plate, arranged on at least one end in the axial direction of the plurality of the divided cores,
wherein the plurality of the slits is formed between each divided core, and
the side core plate comprises:
a plurality of core piece bodies, having the same shape as the plurality of the divided cores and being engaged with each divided core; and
linking portions, respectively link outer circumference portions in the radial direction of the plurality of the core piece bodies.

3. The rotor for electric motor according to claim 2, wherein the rotor core is formed by laminating a plurality of steel sheet materials in the axial direction; and
the side core plate is made of one piece of the steel sheet materials that are arranged on end portions in the axial direction among the steel sheet materials that are laminated.

4. The rotor for electric motor according to claim 3, wherein the steel sheet materials that are laminated are linked with one another by convex portions and concave portions capable of engaging with the convex portions, and the concave portions and the convex portions are formed on respective lamination surfaces.

5. The rotor for electric motor according to claim 2, wherein each divided core is provided with magnet guiding projections, and the magnet guiding projections are formed on at least one of two side surfaces that face the divided cores adjacent in the circumferential direction and formed to protrude along the circumferential direction on an outer side end in the radial direction.

6. The rotor for electric motor according to claim 5, wherein the magnet guiding projections are provided within a projection surface of the linking portions when the rotor core is viewed from the axial direction.

7. The rotor for electric motor according to claim 2, wherein the non-magnetic body has protrusion portions that protrude in the axial direction toward an outside of two end surfaces in the axial direction of the rotor core,
each of protrusion portions has a radial protrusion portion, and the radial protrusion portions of the protrusion portions respectively protrude outward in the radial direction so as to cover a portion of the two end surfaces in the axial direction of the rotor core, and
on one of the two end surfaces in the axial direction of the rotor core, one of the radial protrusion portions extends in the radial direction avoiding the plurality of the slits.

8. The rotor for electric motor according to claim 7, wherein on the other of the two end surfaces in the axial direction of the rotor core, the other one of the radial protrusion portions extends in the radial direction to a position that covers a portion of the plurality of the slits.

9. The rotor for electric motor according to claim 8, wherein the other one of the radial protrusion portions has a plurality of positioning recesses that correspond to the plurality of the slits and determine positions of end portions of the magnets in the axial direction protruding from an end portion in the axial direction of the rotor core.

10. The rotor for electric motor according to claim 7, wherein the plurality of the divided cores and the side core plates are linked with one another by
engaging convexes that are formed on either one of the plurality of the divided cores and the side core plates, and
engaging concaves that are formed on the other one of the plurality of the divided cores and the side core plates and are able to be engaged with the engaging convexes; and
the radial protrusion portions are formed to cover at least a portion of the engaging convexes and the engaging concaves.

11. The rotor for electric motor according to claim 7, wherein the plurality of the divided cores and the side core plates are linked with one another by engaging convexes and engaging holes, in which the engaging convexes are formed on the plurality of the divided cores, and the engaging holes are formed on the side core plates and are able to be fitted to the engaging convexes, and
the radial protrusion portions are formed to cover at least a portion of the engaging convexes and the engaging holes.

12. The rotor for electric motor according to claim 1, wherein a length of the magnets in the axial direction is set to be longer than a length of the rotor core in the axial direction, and
both ends of the magnets in the axial direction respectively protrude from both ends in the axial direction of the rotor core.

13. The rotor for electric motor according to claim 1, wherein the rotor core is configured to be stacked in multiple stages in the axial direction.

14. A brushless motor, comprising:
a rotor for electric motor;
a motor case, rotatably supporting the rotor; and
a stator, fixed inside the motor case and wound by a winding wire supplied with a current,
the rotor further comprising:
a rotary shaft;
a non-magnetic body, formed to cover an outer circumferential surface of the rotary shaft;
a rotor core, linked to the outer circumference of the rotary shaft through the non-magnetic body, and a plurality of slits that extend in an axial direction and a radial direction of the rotary shaft being formed side by side along a circumferential direction of the rotary shaft; and
a plurality of magnets, provided in the plurality of the slits,
wherein the rotor core is formed in a manner that there is a space between an inner circumferential surface side of the rotor core and the outer circumferential surface of the rotary shaft, and
protrusions are provided on an inner circumferential side of the rotor core to suppress the rotor core from being separated from the non-magnetic body outward in the radial direction, and grooves are provided on the non-magnetic body to receive the protrusions and engage with the protrusions.

15. The brushless motor according to claim 14, wherein the rotor core comprises:
a plurality of divided cores, extending in the axial direction and the radial direction, and are arranged radially on the outer circumferential surface of the rotary shaft; and
a side core plate, arranged on at least one end in the axial direction of the plurality of the divided cores,
wherein the plurality of the slits is formed between each divided core, and
the side core plate comprises:
a plurality of core piece bodies, having the same shape as the plurality of the divided cores and being engaged with each divided core; and
linking portions, respectively link outer circumference portions in the radial direction of the plurality of the core piece bodies.

16. The brushless motor according to claim 15, wherein each divided core is provided with magnet guiding projections, and the magnet guiding projections are formed on at least one of two side surfaces that face the divided cores adjacent in the circumferential direction and formed to protrude along the circumferential direction on an outer side end in the radial direction.

17. The brushless motor according to claim 15, wherein the non-magnetic body has protrusion portions that protrude in the axial direction toward an outside of two end surfaces in the axial direction of the rotor core,
each of protrusion portions has a radial protrusion portion, and the radial protrusion portions of the protrusion portions respectively protrude outward in the radial direction so as to cover a portion of the two end surfaces in the axial direction of the rotor core, and
on one of the two end surfaces in the axial direction of the rotor core, one of the radial protrusion portions extends in the radial direction avoiding the plurality of the slits,
on the other of the two end surfaces in the axial direction of the rotor core, the other one of the radial protrusion portions extends in the radial direction to a position that covers a portion of the plurality of the slits.

18. The brushless motor according to claim 17, wherein the other one of the radial protrusion portions has a plurality of positioning recesses that correspond to the plurality of the slits and determine positions of end portions of the magnets in the axial direction protruding from an end portion in the axial direction of the rotor core.

19. The brushless motor according to claim 17, wherein the plurality of the divided cores and the side core plates are linked with one another by
engaging convexes that are formed on either one of the plurality of the divided cores and the side core plates, and
engaging concaves that are formed on the other one of the plurality of the divided cores and the side core plates and are able to be engaged with the engaging convexes; and
the radial protrusion portions are formed to cover at least a portion of the engaging convexes and the engaging concaves.

20. The brushless motor according to claim 17, wherein the plurality of the divided cores and the side core plates are linked with one another by engaging convexes and engaging holes, in which the engaging convexes are formed on the plurality of the divided cores, and the engaging holes are formed on the side core plates and are able to be fitted to the engaging convexes, and
the radial protrusion portions are formed to cover at least a portion of the engaging convexes and the engaging holes.
